(19) United States
(12) Patent Application Publication
(10) Pub. No.: US 2006/0013936 A1
(43) Pub. Date: Jan. 19, 2006

(54) Protein-containing dairy product

(76) Inventor: Anna Miskovsky, Geneva (CH)

Correspondence Address: SOLAE, LLC, PO BOX 88940, ST LOUIS, MO, 63188, US

(21) Appl. No.: 11/183,006

(22) Filed: Jul. 15, 2005

(30) Foreign Application Priority Data
Jul. 16, 2004 (GB) 0416014.9

(51) Int. Cl. A23C 9/154

(52) U.S. Cl. 426/580

(57) ABSTRACT

A membrane filtered soy protein isolate or concentrate can readily be blended with and hydrated by a dairy product, which is preferably liquid, such as milk and/or cream, at relatively low temperatures, e.g. below 30° C. or even below 8° C. The resulting blend can then be acted upon by a yoghurt-forming microorganism to produce a yoghurt-type product, which is comparable with an all dairy yoghurt in taste and mouthfeel.

The present invention relates to a protein-containing dairy product, especially cultured dairy products of the yoghurt type.

With increasing health consciousness has come an increasing desire to introduce soy products, whose health advantages are well known, into a variety of traditional foods that hitherto would not have included them. There is a particular desire to introduce soy protein into dairy products, since unmodified dairy products are well known to carry some degree of risk of hypercholesterolaemia. The incorporation of soy into dairy products, however, represents a particular problem, since soy products, especially soy protein products, do not hydrate easily in liquid dairy products and can generally only be hydrated with heating, in order to achieve full functionality and ideal eating characteristics. Heating is undesirable, since it adds two processing steps (heating and subsequent cooling) and thus increases cost, because it changes the taste and sometimes other characteristics of the material being heated, and because it may promote spoilage of the dairy product unless special hygiene measures are taken. Even where the protein appears to have hydrated satisfactorily, the resultant product is often unsatisfactory in sensory evaluation tests, appearing to have a gritty mouthfeel and reduced viscosity.

We have now surprisingly found that a membrane filtered soy protein isolate or concentrate, unlike the acid-precipitated equivalent, can be cold blended with liquid dairy products. By “cold blending”, we mean blending at a temperature at about ambient or below. Moreover the resulting product has better taste and mouthfeel characteristics than a similar product made using conventional acid-precipitated soy protein, which has been subjected to either a cold or a hot hydration step.

Thus, the present invention consists in a process for producing a soy protein-fortified dairy product which comprises blending a membrane filtered soy protein isolate or concentrate into a non-solid dairy product at a temperature not greater than 30° C.

It is crucial that the soy protein product employed in the process of the present invention should be a membrane filtered product, since it is this that allows the unique cold blending which is a major advantage of the present invention. Such a product may be prepared, for example, as described in WO 02/080697.

WO 02/080697 describes a method for manufacturing a soy protein concentrate that comprises the steps of: (a) providing a defatted soybean material, (b) adding water to the material to form a slurry, (c) removing fibre from the slurry to produce a suspension, and (d) ultrafiltering the suspension using a membrane having a molecular weight cut-off (MWCO) of up to 30,000. Preferably, a membrane having a MWCO of between 10,000 and 30,000 is used.

The defatted soybean material may be soy flakes or soy flour. The defatted material may contain less than about 1.0 wt. % fat, at least 45 wt. % protein and have a protein dispersability index (PDI) of about 90. The defatted material may further contain about 30 to 40 wt. % carbohydrates, and about 5 to 10 wt. % moisture.

For use in the present invention, the membrane used preferably has, as in WO 02/080697, a MWCO of up to 30,000, more preferably from 10,000 to 30,000.

The soy protein employed in the process of the present invention may be an isolate or a concentrate. As used herein, the term “soy protein concentrate” refers to a soy protein-containing material that contains from 65% up to 90%, preferably at least 70% but less than 90%, and most preferably at least 75% but less than 90%, soy protein by weight on a moisture free basis. As used herein, the term “soy protein isolate” refers to a soy protein-containing material that contains at least 90% soy protein by weight on a moisture free basis. We prefer that the soy protein material should be a soy protein concentrate, that is that it should contain from 65 to 90%, preferably at least 70% but less than 90%, and most preferably at least 75% but less than 90%, soy protein by weight on a moisture-free basis.

Particularly preferred examples of a membrane filtered soy protein concentrate are the Alpha™ 5800 series of products, for example Alpha™ 5812, a product of Solae LLC, St Louis, Mo. (formerly Central Soya).

The dairy product employed in the present invention is preferably liquid at the temperature at which the process is carried out. However, it may also be in other non-solid physical states, provided that it is capable of being mixed with the soy protein to produce a uniform blend, and that it is capable of hydrating the soy protein. Examples of liquid dairy products which may be employed in the present invention include liquid whole milk, liquid reduced fat milk, including those grades known as skimmed and semi-skimmed milk (fat free milk and low fat milk), reconstituted dried whole milk, reconstituted dried reduced fat milk, including those grades known as skimmed and semi-skimmed milk (fat free milk and low fat milk), cream, buttermilk and liquid yoghurt. If desired, a combination of any two or more of these liquid dairy products may be employed. Butterfat, or other fat-containing materials, may also be added, if desired, in order to achieve a desired fat level.

If desired, the dairy product may be in the form of a gel, emulsion, or sol, rather than a liquid. Such a form is particularly possible if the dairy product is a yoghurt.

Before the processing, the liquid dairy products may be standardized to a desired fat content. This may be carried out using conditions and equipment well known to those skilled in the art.

The soy protein may be blended into the liquid dairy product using any conventional high shear blending device commonly used in this field, for example a Likwifier from Breddo or an Almix from Tetra Pak.

The amount of soy protein incorporated into the dairy product is not critical to the present invention, and may be decided on the basis of the desired nutritional content, flavour and organoleptic properties of the final product. By way of guidance, we generally prefer to employ an amount of the soy protein sufficient to provide from 5 to 50% by weight of the total protein in the final product, more preferably from 10 to 40%, and most preferably from 20 to 30%. If the amount of protein is too high, this will reduce the amount of dairy in the final product and this may have an adverse effect on taste and mouthfeel. On the other hand, if the amount is too low, little benefit will be achieved by its incorporation.

The temperature at which the soy protein is blended into the dairy product is not greater than about 30° C. However, it is more generally preferred that the temperature should be no greater than ambient, so that the blending is done without external heating. More preferably for hygiene reasons, the dairy product is preferably maintained at a relatively low temperature, and so a preferred temperature is no greater than 20° C. However, dairy products are normally kept, indeed legislation often prescribes that they are kept, under refrigerated conditions, in which case, the soy protein may be blended into the dairy product while the dairy product is still at its refrigerated temperature, e.g. no greater than 8° C., and preferably less than 5° C. The minimum temperature for blending is a temperature just above that at which the liquid dairy product freezes. If desired, water may be added before or after blending either to facilitate blending or to adjust the taste or nutritional content of the final product.

If desired, before, after or simultaneously with the blending, other ingredients may be incorporated into the blend of the present invention. Examples of such other ingredients include: sweeteners, such as sucrose, fructose, sucralose, saccharin, cyclamate or aspartame; flavourings, including both natural and artificial flavourings, such as fruit flavours, cocoa, chocolate, coffee, vanilla, caramel, or butterscotch; and solid ingredients, such as fruit pieces, nuts, cereals etc.

It may also be desired to include water in the composition, either to improve flowability or to adjust the flavour or nutritional content or both. Where water is included, the amount may vary over a wide range, for example from 1 to 40% by weight of the whole composition, more preferably from 2 to 30% by weight. However, water is not an essential component and may be omitted, if desired.

Other conventional additives, such as vitamins and/or minerals may be included in the compositions of the present invention, as is well known in the art.

In a preferred embodiment of the present invention, the dairy/soy blend is used to prepare a soy-fortified cultured dairy product of the yoghurt type. If desired, the soy protein may simply be blended with a finished yoghurt product. However, it is more preferred to blend the soy with a liquid dairy product, such as liquid whole milk, liquid reduced fat milk, reconstituted dried whole milk, reconstituted dried reduced fat milk, cream or buttermilk, and then subject the blend to culture with a yoghurt-forming microorganism. After the dairy product has been converted to yoghurt, other conventional ingredients, including any one or more of the sweeteners, flavours or solid ingredients listed above, may be added. Certain of these ingredients, such as the sweeteners, are conventionally added prior to fermentation. However, these may be added, and the other flavouring ingredients (such as fruit flavours, or cocoa, chocolate, coffee, vanilla, caramel, or butterscotch flavours) and solid ingredients (such as fruit pieces, nuts, or cereals) preferably are added after fermentation.

Examples of yoghurt-forming microorganisms which may be used in the present invention include various Lactobacillus species, including: L. casei (e.g. L. casei subsp. casei), L. delbrueckii (e.g. L. delbrueckii subsp. delbrueckii, L. delbrueckii subsp. lactis or L. delbrueckii subsp. bulgaricus), or L. acidophilus; various Streptococcus species, including Str. thermophilus; various Lactococcus species, including Lac. lactis (e.g. Lac. lactis subsp. cremoris or Lac. lactis subsp. lactis). Probiotics, such as various Bifidobacterium species and L. acidophilus species may also be added. A particularly preferred culture is YC 085 or YC 180 from Chr. Hansen A/S 10-12 Boege Alle, DK-2970 Hoersholm, which is made up of strains of Streptococcus thermophilus, Lactobacillus delbrueckii subsp. bulgaricus and L. delbrueckii subsp. lactis.

The amount of microorganism added should be in accordance with the microorganism supplier's instructions, as though the whole of the material being treated (including the soy) were dairy. This amount will, of course, vary depending on the microorganism, and the type of yoghurt to be prepared. In general, we prefer to use from 0.01 to 0.1% by weight of the microorganism, based on the weight of the whole product, more preferably about 0.06% by weight.

The temperature at which the fermentation takes place and the time for which the microorganism is cultured will vary depending on the microorganism, the dairy product treated, and the type of yoghurt to be produced. However, a preferred temperature is generally within the range from 39 to 44° C., more preferably about 42° C. The time required is heavily dependent on the nature of the microorganism, as well as upon the inoculation rate, incubation temperature, and carbohydrate level of the base. However, in general terms, a period of from 5 to 10 hours is preferred. The fermentation is usually continued until the yoghurt has achieved the correct pH value, e.g. a value within the range from 4 to 5, preferably about 4.5. However, if desired, an acid, such as lactic acid, may be added to adjust the fermented product to the desired pH value.

When the fermentation period is over, the yoghurt is then preferably cooled and packaged.

In a preferred embodiment of the present invention, the process comprises the following steps:

(1) Combine water (if used), and all dairy containing ingredients.

(2) Add protein and sugar (if used) by mixing (at high speed) e.g. for 10 minutes.

(3) Pasteurise at the appropriate time and temperature (for example at 92° C. for 30 minutes).

(4) Homogenize at 140/35 bar (1st/2nd stage).

(5) Cool and maintain at a temperature that is ideal for the culture selected. Using the preferred microorganism culture, this would be at 42° C.

(6) Add culture and mix to incorporate.

(7) Incubate at 42° C. until the pH drops to about 4.5.

(8) Cool to less than 5° C., add fruit preparation, nuts, etc., if desired, and package.

The present invention is further illustrated by the following non-limiting Examples.

### EXAMPLES 1-4

Preparation of Plain Cultured Dairy Products

The ingredients shown in the following Table 1 were used to manufacture 4 kinds of yoghurt or yoghurt-type products, that of Example 1 being all dairy, that of Example 2 (an example of the invention) having 25% of its protein content derived from membrane filtered soy protein concentrate Alpha 5812 and blended cold, that of Example 3 having 25% of its protein content derived from Supro 760 and blended hot and that of Example 4 having 25% of its protein content derived from Supro 760 and blended cold.

The procedure for Examples 1, 2 and 4 was as follows. The water, milk and cream were combined cold (5° C.). Protein or NFDM (non-fat dried milk) and sugar were added and dispersed well by mixing (at high speed) for 10 minutes using a Yamato Sted Fast Stirrer model SL 2400 (Yamato Scientific America, Inc., 385 Oyster Point Blvd. Suite 8B, South San Francisco, Calif. 94080). Although not required, the mixture was, for ease of use, allowed to sit overnight (about 8-12 hours) in refrigeration (about 5° C.), which is understood in the dairy industry to optimise the flavour of hydrated milk solids. The mixture was pasteurised 85-88° C. for 30-45 minutes, after which it was cooled to 79.4° C. (175° F.). It was then homogenized in an APV two stage homogeniser (Invensys APV, Zechenstrasse 49, D-59425 Unna, GERMANY) at 140/35 bar (1st/2nd stage).

The product was then cooled to 50° C. (122° F.) and weighed into a sterile container. 1 part by weight of the culture was mixed with 9 parts of yoghurt base and a sufficient amount of this was added to the cooled product to dose a final concentration of 0.06% culture. The mixture was then mixed gently for 30-60 seconds. It was then incubated at 42° C. (108° F.) until the pH dropped to 4.5. The product was then stirred, after which it was refrigerated at 2-4° C. (36-39° F.) for at least 24 hours before consuming.

The procedure for Example 3 was as follows: Milk, cream and water were added to a steam kettle and heated to ˜35° C. (˜95° F.). Soy protein was added and dispersed well by mixing (at high speed) for 5 minutes using a Yamato Sted Fast Stirrer model SL 2400. The mixture was then heated to 70° C. (158° F.) slowly, so as to avoid burning the slurry. The heating was discontinued, and mixing was continued gently (at low speed) for 15 minutes. At the end of this time, sugar was added and mixing was continued (at low-medium speed) for 1 minute.

The mixture was then pasteurised at 85-88° C. for 30-45 minutes. At the end of this time, the mixture was homogenized in an APV two stage homogeniser at 175/35 bar (1st/2nd stage), at 70° C. (158° F.). The mixture was then cooled to 50° C. (122° F.) and weighed into sterile container. 1 part by weight of the culture was mixed with 9 parts of yoghurt base and a sufficient amount of this was added to the cooled product to dose a final concentration of 0.06% culture. The mixture was then mixed gently for 30-60 seconds. It was then incubated at 42° C. (108° F.) until the pH dropped to 4.5. The product was then stirred, after which it was refrigerated at 2-4° C. (36-39° F.) for at least 24 hours before consuming.

The nutritional profile of the 4 plain yoghurt or yoghurt-type products, per 100 g serving, was as shown in Table 2.

TABLE 1

| | Example 1 | | Example 2 | | Example 3 | | Example 4 | |
|---|---|---|---|---|---|---|---|---|
| Solae Soy Product Used | none | | Alpha 5812 | | Supro 760 | | Supro 760 | |
| Amount of Soy Protein (% of Total Protein) | 0% | | 25% | | 25% | | 25% | |
| | Cold blend | | Cold blend | | Hot blend | | Cold blend | |
| Ingredients | % | g/Batch | % | g/Batch | % | g/Batch | % | g/Batch |
| Water, Deionised | 3.39 | 271.44 | 5.25 | 183.75 | 5.36 | 187.43 | 5.36 | 187.43 |
| NFDM, Premium - ConAgra - Product | 2.92 | 233.36 | | | | | | |
| Code Sanalac | | | | | | | | |
| Alpha 5812 - Solae | | | 1.37 | 47.85 | | | | |
| Supro Plus 760 - Solae | | | | | 1.18 | 41.13 | 1.18 | 41.13 |
| Cream, Heavy, Grade A, 40% Fat - Pevely | 2.70 | 215.60 | 2.69 | 93.98 | 2.61 | 91.18 | 2.61 | 91.18 |
| Milk, 3.2% Fat - Brookfield Farms | 88.82 | 7,105.20 | 88.52 | 3,098.13 | 88.69 | 3,103.98 | 88.69 | 3,103.98 |
| Sucrose | 1.58 | 126.40 | 1.58 | 55.30 | 1.58 | 55.30 | 1.58 | 55.30 |
| Culture, 1/10 Dilution - Chr. Hansen - Product | 0.60 | 48.00 | 0.60 | 21.00 | 0.60 | 21.00 | 0.60 | 21.00 |
| Code YC-180 | | | | | | | | |
| Total | 100.00 | 8,000.00 | 100.00 | 3,500.00 | 100.00 | 3,500.00 | 100.00 | 3,500.00 |

| | | | | |
|---|---|---|---|---|
| Elapsed Time (Hours:Minutes) | 06:30 | 05:30 | 06:00 | 05:30 |
| Final pH | 4.55 | 4.44 | 4.45 | 4.46 |

TABLE 2

| | Example 1 | Example 2 | Example 3 | Example 4 |
|---|---|---|---|---|
| Total Protein, grams | 4.10 | 4.10 | 4.10 | 4.10 |
| of which is soy protein | 0.00 | 1.03 | 1.03 | 1.03 |
| of which is milk protein | 4.10 | 3.08 | 3.08 | 3.08 |
| Fat, grams | 4.00 | 4.00 | 4.00 | 4.00 |
| Total carbohydrate, | 8.13 | 6.63 | 6.47 | 6.47 |
| grams | | | | |
| Fibre | 0.00 | 0.03 | 0.00 | 0.00 |
| Total calories, KJ | 356 | 330 | 328 | 328 |
| Total calories, kcal | 85 | 79 | 78 | 78 |

### EXAMPLES 5-8

Preparation of Flavoured Cultured Dairy Products

The ingredients shown in the following Table 3 were used to manufacture 4 kinds of yoghurt or yoghurt-type product, that of Example 5 being all dairy with an added yoghurt fruit base, that of Example 6 (an example of the invention) having 25% of its protein content derived from membrane filtered soy protein concentrate Alpha 5812 and blended cold with an added yoghurt fruit base, that of Example 7 having 25% of its protein content derived from Supro 760 and blended hot with an added yoghurt fruit base and that of Example 8 having 25% of its protein content derived from Supro 760 and blended cold with an added yoghurt fruit base.

The procedure for preparation of Examples 5, 6, 7 and 8 was as follows. Fermented product of Example 1, 2, 3 or 4 was weighed and mixed by hand with the indicated amount of the Peach—Mango natural flavour yoghurt fruit base, product number 275635983 from Sensient Flavors, Inc, 5600 West Raymond Street, Indianapolis, 1N, 48241, USA.

TABLE 3

| | Example 5 | Example 6 | Example 7 | Example 8 |
|---|---|---|---|---|
| Example 1 post | 85.00 | 0.0 | 0.0 | 0.0 |
| fermentation | | | | |
| Example 2 post | 0.0 | 85.00 | 0.0 | 0.0 |
| fermentation | | | | |
| Example 3 post | 0.0 | 0.0 | 85.00 | 0.0 |
| fermentation | | | | |
| Example 4 post | 0.0 | 0.0 | 0.0 | 85.00 |
| fermentation | | | | |
| Sensient fruit base | 15.00 | 15.00 | 15.00 | 15.00 |
| 275635983 | | | | |
| Total | 100.00 | 100.00 | 100.00 | 100.00 |

The nutritional profile of the fruit containing yoghurt or yoghurt-type products, per 100 g serving, was as shown in Table 4.

TABLE 4

| | Example 5 | Example 6 | Example 7 | Example 8 |
|---|---|---|---|---|
| Total Protein, grams | 3.51 | 3.51 | 3.51 | 3.51 |
| of which is soy protein | 0.00 | 0.87 | 0.87 | 0.87 |
| of which is milk protein | 3.51 | 2.61 | 2.61 | 2.61 |
| Fat, grams | 3.41 | 3.41 | 3.41 | 3.41 |
| Total carbohydrate, | 14.98 | 13.59 | 13.53 | 13.53 |
| grams | | | | |
| Fibre | 0.06 | 0.08 | 0.06 | 0.06 |
| Total calories, KJ | 439 | 415 | 415 | 415 |
| Total calories, kcal | 104 | 99 | 99 | 99 |

### EXAMPLE 9

Sensory Evaluation—Descriptive Profiling on Plain Yoghurt or Yoghurt-Type Products

The yoghurt products prepared as described in Example 1 were subjected to sensory evaluation tests in accordance with the procedure described in “Sensory Evaluation Manual 26 Sensory Testing Methods”, Second Edition Editor(s): Edgar Chambers IV; Mona Baker Wolf, Published 1996, ISBN:0-8031-2068-0. The profiling sensory method is as described on pages 65-67.

Ten trained descriptive panellists evaluated the yoghurts in triplicate. Nineteen flavour and eight texture attributes were evaluated in each sample. Yoghurt containers were combined and ˜2 ounces of product was scooped into two ounce Solo cups and lidded.

Each panellist independently rated the intensity of each sample's flavour attributes on a 15-point intensity scale, with 0=none and 15=very strong. Samples were randomised and presented monadically in duplicate.

Analysis of Variance (ANOVA) was performed to test product and replication effects. When the ANOVA result was significant, multiple comparisons of means were performed using the Tukey's t-test. Differences can be noted in the following tables as values not sharing the same letter. Where letters are different there is a statistically significant difference at a<0.05 level.

The results for flavour profiling are represented in the following Tables 5 to 7. For flavour attributes, mean values <1.0 indicate that not all panellists perceived the attribute in the sample.

TABLE 5
Important Yoghurt Aromatic Attributes

| | Example 1 | Example 2 | Example 3 | Example 4 |
|---|---|---|---|---|
| Overall flavour impact | 7.9a | 7.7b | 7.8ab | 7.9a |
| Dairy | 2.8a | 2.7a | 2.4a | 2.3a |
| Cultured | 5.0a | 5.0a | 4.8a | 4.4a |
| Soy/Legume | 0.6b | 0.8b | 1.8a | 1.7a |
| Grain | 0.0b | 0.2ab | 0.5a | 0.3ab |
| Vegetative | 0.1a | 0.0a | 0.0a | 0.0a |
| Sweet aromatics | 0.0a | 0.0a | 0.0a | 0.0a |
| Yeasty/Fermented | 0.2c | 0.9b | 2.1a | 2.0a |
| Mineral | 0.1a | 0.0a | 0.1a | 0.2a |
| Oxidised | 0.0a | 0.0a | 0.0a | 0.0a |
| Fruity/Citrus | 2.1a | 0.9b | 0.0c | 0.3c |
| Cardboard | 0.0a | 0.0a | 0.0a | 0.0a |
| Degraded protein | 0.0a | 0.0a | 0.0a | 0.0a |

TABLE 6
Important Yoghurt Tastes

| | | | |
|---|---|---|---|
| Example 1 | Example 2 | Example 3 | Example 4 |

Basic tastes

| | | | | |
|---|---|---|---|---|
| Sweet | 1.6a | 1.5a | 1.1b | 1.6a |
| Sour | 4.6a | 4.6a | 4.8a | 4.8a |
| Salt | 0.6a | 0.6a | 0.7a | 0.5a |
| Bitter | 2.1a | 2.1a | 2.2a | 2.2a |

Chemical feeling factors

| | | | | |
|---|---|---|---|---|
| Astringent | 3.0ab | 2.9b | 3.2a | 3.1ab |
| Burn | 0.2b | 0.6a | 0.5ab | 0.4ab |
| Prickly | 0.0a | 0.0a | 0.1a | 0.0a |

TABLE 7
Important Yoghurt Mouthfeel Attributes

| | Example 1 | Example 2 | Example 3 | Example 4 |
|---|---|---|---|---|
| Initial viscosity | 11.69a | 11.93a | 10.52b | 10.57b |
| Amount of particles | 0.0a | 0.0a | 0.2a | 0.5a |
| Particle size | 0.0a | 0.1a | 0.0a | 0.1a |
| Viscosity at 10 | 9.69a | 9.84a | 8.62b | 8.70b |
| manipulations | | | | |
| Mixes with saliva | 13.5a | 13.4a | 13.5a | 13.5a |
| Chalky mouthcoating | 1.9a | 1.9a | 1.9a | 2.0a |
| Slick mouthcoating | 0.0a | 0.0a | 0.0a | 0.0a |
| Tacky mouthcoating | 0.1a | 0.2a | 0.1a | 0.0a |

Of particular interest in these data is the fact that the membrane filtered product of Example 2 was found to have equal soy/legume aromatic intensity to the all-dairy control of Example 1 (see Table 5). The presence of a soy/legume characteristic is typical for a soy containing formula and it is remarkable that it is not only lower than the acid precipitated samples but found to be equal to the all dairy control sample. As this soy/legume note is known by those experts in soy product formulation and manufacture to drive down the level of consumer acceptance of soy containing products this is considered an important advantage of this invention.

From the results above it can be seen that the yoghurt-type product of Example 2, the product of the present invention, is not significantly different from the ideal of the all-dairy yoghurt (Example 1) as are those of Example 3 and 4, and is significantly closer in important mouthfeel characteristics, especially initial viscosity and viscosity after 10 manipulations. This measurement of sensory attributes confirms the unique performance of the membrane filtered soy as it builds more functionality and mouthfeel in the presence of dairy ingredients and it is not gritty.

### EXAMPLE 10

Consumer Hedonic Acceptance Testing on Flavoured Yoghurt or Yoghurt-Type Products

The findings in Example 9 were confirmed in a consumer sensory test to determine the overall liking of the 4 samples of Examples 5-8, to which fruit had been added.

The judges were 60 males and females, ages 35-54, who had expressed an interest in making healthy food choices, and were willing to try soy-containing fruit flavoured yoghurt-type products.

The test was carried out as described in “Sensory Evaluation Manual—26 Sensory Testing Methods”, Second Edition Editor(s): Edgar Chambers IV; Mona Baker Wolf, Published 1996, ISBN:0-8031-2068-0, pages 73-75.

The sensory attributes tested were:

### Overall Liking

### Liking of Appearance

### Flavour Liking

### Mouthfeel/Texture Liking

All tests were recorded on a 9 point scale, where 1=Dislike Extremely, and 9=Like Extremely.

Yoghurts/cultured desserts were stirred and spooned into 2.5 ounce Solo soufflé cups with lids, and refrigerated until given to panellists. The serving protocol was Sequential Monadic (one at a time) presentation.

Data Analysis: Analysis of Variance, accounting for panellist and sample effects, with mean separations using Tukey's Honestly Significant Difference (HSD) Test. The results are summarised in the following Table 8.

TABLE 8
Summary of Consumer Hedonic Acceptance

| Liking | Example 5 | Example 6 | Example 7 | Example 8 |
|---|---|---|---|---|
| Overall | 6.43a | 6.35ab | 5.78c | 5.9bc |
| Appearance | 7.3a | 7.15ab | 6.95b | 7.05b |
| Flavour | 6.4a | 6.13ab | 5.72b | 5.88ab |
| Mouthfeel/Texture | 6.57a | 6.4a | 5.78b | 6.08ab |

The mean liking scores found in Table 8 that do not share a common letter are significantly different at 95% confidence. The sample made with the membrane filtered soy protein was the only sample found to be not significantly different for consumer liking for all attributes tested compared to the all dairy control. The key metric in this test is the overall consumer liking, and both acid precipitated proteins, whether hydrated hot or cold, were liked significantly less than the all dairy sample. On the other hand, the membrane filtered sample of Example 6 was liked the same as the all dairy control of Example 5.

### EXAMPLE 11

Soy-Containing Pudding

The ingredients used are as shown in the following Table 9.

TABLE 9

| | |
|---|---|
| Cream | 2.61 |
| Full fat milk | 85.86 |
| Membrane filtered soy protein Alpha 8212 | 1.33 |
| Food starch | 2.00 |
| Sugar | 7.79 |
| Dextrose | 0.00 |
| Carrageenan | 0.10 |
| Salt | 0.30 |
| potassium sorbate | 0.01 |
| Total | 100 |

The procedure used was as follows. The protein was added to a mixture of the cold milk and cream. The mixture was stirred to dissolve the protein. The remaining dry ingredients were combined and blended well. The combined dry ingredients were added to the protein/milk/cream slurry, while agitating with a mixer. The mixture was homogenized at 140/35 bar (1st/2nd stage). The mixture was heated to 79-82° C. and held for 5 minutes. At the end of this time, the mixture was removed from the heat and cooled to room temperature. It was then packaged.

The nutritional profile of the product, per 100 g serving, was as shown in Table 10.

TABLE 10

| | |
|---|---|
| Total Protein, grams | 4.00 |
| of which is soy protein | 1.00 |
| of which is milk protein | 3.00 |
| Fat, grams | 4.00 |
| Total carbohydrate, grams | 14.00 |
| Fibre | 0.03 |
| Total calories, KJ | 453 |
| Total calories, kcal | 108 |

### EXAMPLE 12

Drinkable Yoghurt

The ingredients used are as shown in the following Table 11.

TABLE 11

| | |
|---|---|
| Water, Deionised | 51.53 |
| Membrane filtered soy protein | 0.69 |
| Cream, Heavy, Grade A, 40% Fat | 1.35 |
| Milk, 3.2% Fat | 44.26 |
| Sucrose | 1.58 |
| Culture | 0.60 |
| Total | 100.00 |

The procedure used was as follows. The water, milk and cream were combined, and then the protein and sugar were added, and the mixture was mixed (at high speed) for 10 minutes. It was then pasteurised at 85-88° C. for 30-45 minutes. At the end of this time, it was homogenized at 140/35 bar (1st/2nd stage). It was then cooled to 42° C.

The culture was added and mixed to incorporate. It was then incubated at 42° C. until the pH dropped to 4.5. It was cooled to less than 5° C., after which a fruit preparation and/or flavours can be added, if desired. It is then packaged.

The nutritional profile of the plain product, per 100 ml serving, was as shown in Table 12.

TABLE 12

| | |
|---|---|
| Total Protein, grams | 2.00 |
| of which is soy protein | 0.50 |
| of which is milk protein | 1.50 |
| Fat, grams | 2.00 |
| Total carbohydrate, grams | 4.00 |
| Fibre | 0.00 |
| Total calories, KJ | 176 |
| Total calories, kcal | 42 |

### EXAMPLE 13

Beverage

The ingredients used are as shown in the following Table 13.

TABLE 13

| | |
|---|---|
| Water, Deionised | 6.43 |
| Membrane filtered soy protein | 1.37 |
| Cream, Heavy, Grade A, 40% Fat | 2.69 |
| Milk, 3.2% Fat | 88.52 |
| Sucrose | 1.00 |
| Total | 100.00 |

The procedure used was as follows. Water, milk and cream (cold) were combined. Protein and sugar were added and by mixed (at high speed) for 10 minutes. The product was then pasteurised to achieve the desired shelf life. It was then homogenized at 140/35 bar (1st/2nd stage), cooled and packaged.

The nutritional profile of the product, per 100 ml serving, was as shown in Table 14.

TABLE 14

| | |
|---|---|
| Total Protein, grams | 4.00 |
| of which is soy protein | 1.00 |
| of which is milk protein | 3.00 |
| Fat, grams | 4.00 |
| Total carbohydrate, grams | 5.00 |
| Fibre | 0.00 |
| Total calories, KJ | 301 |
| Total calories, kcal | 72 |

1. A soy protein-fortified dairy product comprised of: a membrane filtered soy protein product cold blended with a non-solid dairy product.

2. The soy protein-fortified dairy product of claim 1, wherein the membrane filtered soy protein product is selected from the group consisting of membrane filtered soy protein concentrate and membrane filtered soy protein isolate.

3. The soy protein-fortified non-solid dairy product of claim 1, wherein the dairy product is selected from the group consisting of liquid whole milk, liquid reduced fat milk, liquid skimmed milk, liquid semi-skimmed milk, reconstituted dried whole milk, reconstituted dried reduced fat milk, reconstituted dried skimmed milk, reconstituted semi-skimmed milk, cream, buttermilk, liquid yoghurt, and mixtures thereof.

4. The soy protein-fortified dairy product of claim 1, further comprising ingredients selected from the group consisting of sucrose, fructose, sucralose, saccharin, cyclamate, aspartame, natural flavourings, artificial flavourings, fruit pieces, nuts, cereals, water, vitamins, minerals, and mixtures thereof.

5. The soy protein-fortified dairy product of claim 1, wherein the soy protein-fortified dairy product is selected from the group consisting of plain cultured dairy products, flavoured cultured dairy products, puddings, beverages, and drinkable yoghurts.

6. The soy protein-fortified dairy product of claim 1, wherein the soy protein product is 5% to 50% by weight to the total protein in the final product.

7. The soy protein-fortified dairy product of claim 1, wherein the membrane filtered soy protein product has been filtered using a membrane having a molecular weight cut-off up to 30,000.

8. A process for producing a soy protein-fortified dairy product which comprises blending a membrane filtered soy protein product into a non-solid dairy product at a temperature not greater than 30° C.

9. The process according to claim 8, in which the blend of the membrane filtered soy protein product and the non-solid dairy product is subjected to culture with a yoghurt-forming microorganism.

10. The process according to claim 8, wherein the membrane filtered soy protein product has been filtered using a membrane having a molecular weight cut-off up to 30,000.
